(19) United States
(12) Patent Application Publication
(10) Pub. No.: US 2015/0308167 A1
(43) Pub. Date: Oct. 29, 2015

(54) EXIT LOCK ASSEMBLY

(71) Applicant: GIANNI INDUSTRIES INC., New Taipei City (TW)

(72) Inventor: Chih-Chung CHANG, New Taipei City (TW)

(73) Assignee: GIANNI INDUSTRIES INC., New Taipei City (TW)

(21) Appl. No.: 14/260,318

(22) Filed: Apr. 24, 2014

(51) Int. Cl. E05C 3/00

(52) U.S. Cl. CPC E05C 3/002

(57) ABSTRACT

An exit lock assembly is provided. The exit lock assembly comprises a base, two doorstops, two first links, two second links, two solenoid valves and a cover. The base and the cover are combined to form a receiving space to receive the two doorstops, the two first links, the two second links and the two solenoid valves. The doorstops are closed in an initial position when the solenoid valves are not energized. When the solenoid valves are energized, two plugs of the two solenoid valves move along the direction opposite a central area and drive two fifth ends of the two second links, two fourth ends of the two second links thus get away from the third ends of the first links, and the second end of the doorstop moves down and makes the doorstops in an open status.

### CROSS-REFERENCES TO RELATED APPLICATIONS

Not applicable.

### BACKGROUND OF THE INVENTION

1. Field of the Invention

The present invention relates to an exit lock assembly, and more particularly, to an exit lock assembly capable of controlling the open status and close status of the doorstops via the solenoid valve.

2. Descriptions of the Related Art

As shown in FIG. 1, an exit 100 disposed on the public space in the prior art needs to be open via the press-push mode. However, when encountered an emergency, the user is often trying to open the exit 100 via the wrong push-press mode.

Thus, the aforementioned wrong push-press mode is likely to cause the exit 100 in a stuck case, and resulting in inconvenience and danger of escape.

In view of this, it is important to provide an exit lock assembly to avoid the above stuck case.

### SUMMARY OF THE INVENTION

An objective of the present invention is to provide an exit lock assembly that the user can easy open when it are energized.

To achieve the aforesaid objective, a first embodiment of the exit lock assembly comprises a base, two doorstops, two first links, two second links, two solenoid valves and a cover. The base has a central area and two side areas disposed at two sides of the central area, the central area has two first axes and two second axes opposite to each other, and the side area has two third axes. The two doorstops are disposed at the two first axes of the central area, and have a first end and a second end respectively. The two first links are disposed at the two second axes of the central area, and have a third end for holding the second end of the doorstop respectively. The two second links are disposed at the two third axes of the side areas. The two second links have a fourth end and a fifth end respectively, and the fourth end is adapted to hold the third end of the first links in a holding status. The two solenoid valves are disposed at an outer edge of the two side areas, each the two solenoid valves has a plug respectively, and the plug is adapted to join the fifth end of the second link. The cover is adapted to combine with the base to form a receiving space for receiving the two doorstops, the two first links, the two second links and the two solenoid valves. When the solenoid valves are energized, the two plugs of the two solenoid valves move along the direction opposite the central area and drive the two fifth ends of the two second links, the two fourth ends of the two second links thus separate from the third ends of the first links, and the second end of the doorstop moves down.

To achieve the aforesaid objective, a second embodiment of the exit lock assembly comprises a base, two doorstops, two first links, two solenoid valves and a cover. The base has a central area and two side areas disposed at two sides of the central area, the central area has two first axes and two second axes opposite to each othe. The two doorstops are disposed at the two first axes of the central area, and has a first end and a second end respectively. The two first links are disposed at the two second axes of the central area, each the first links has a third end and a projection, and the third end is adapted to hold the second end of the doorstop respectively. The two solenoid valves are disposed at the two side areas, each the two solenoid valves has a plug respectively, and the plug hold the projection of the first link in a holding status. The cover is adapted to combine with the base to form a receiving space for receiving the two doorstops, the two first links and the two solenoid valves. When the solenoid valves are energized, the two plugs of the two solenoid valves move along the direction opposite the central area so as the projection of the two first links break away from the holding status, and the second end of the doorstop moves down.

The detailed technology and preferred embodiments implemented for the subject invention are described in the following paragraphs accompanying the appended drawings for people skilled in this field to well appreciate the features of the claimed invention.

### BRIEF DESCRIPTION OF THE DRAWINGS

FIG. 1 is a schematic view of an exit in prior art;

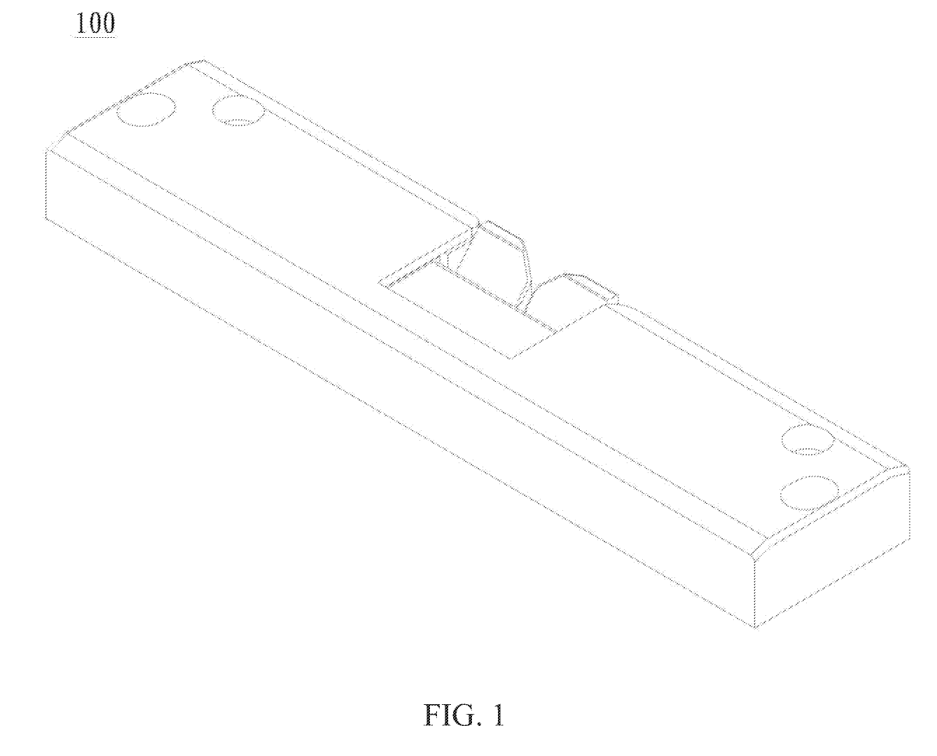

FIG. 2 is an exploded view of the first embodiment of the exit lock assembly according to the present invention;

FIG. 3 is a schematic view of the first embodiment of the exit lock assembly according to the present invention when in the close (off) mode;

FIG. 4 is an acting view of the first embodiment of the exit lock assembly according to the present invention when in the energized mode;

FIG. 5 is a link acting view of the first embodiment of the exit lock assembly according to the present invention when in the close (off) mode;

FIG. 6 is a link acting view of the first embodiment of the exit lock assembly according to the present invention when in the energized mode;

FIG. 7 is a link acting view of the first embodiment of the exit lock assembly according to the present invention when in the open status;

FIG. 8 is an exploded view of the second embodiment of the exit lock assembly according to the present invention;

FIG. 9 is a schematic view of the second embodiment of the exit lock assembly according to the present invention when in the close (off) mode;

FIG. 10 is an acting view of the second embodiment of the exit lock assembly according to the present invention when in the energized mode;

FIG. 11 is a link acting view of the second embodiment of the exit lock assembly according to the present invention when in the energized mode; and

FIG. 12 is a link acting view of the second embodiment of the exit lock assembly according to the present invention when in the open status.

### DESCRIPTION OF THE PREFERRED EMBODIMENT

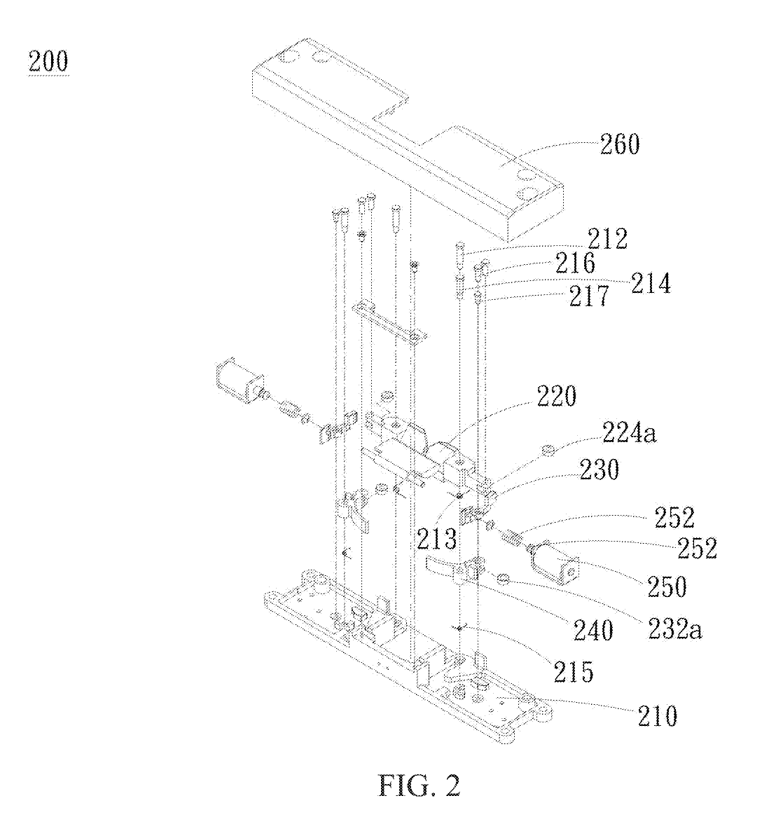

As shown in FIG. 2, a first embodiment of the present invention of an exit lock assembly 200 comprises a base 210, two doorstops 220, two first links 230, two second links 240, two solenoid valves 250 and a cover 260.

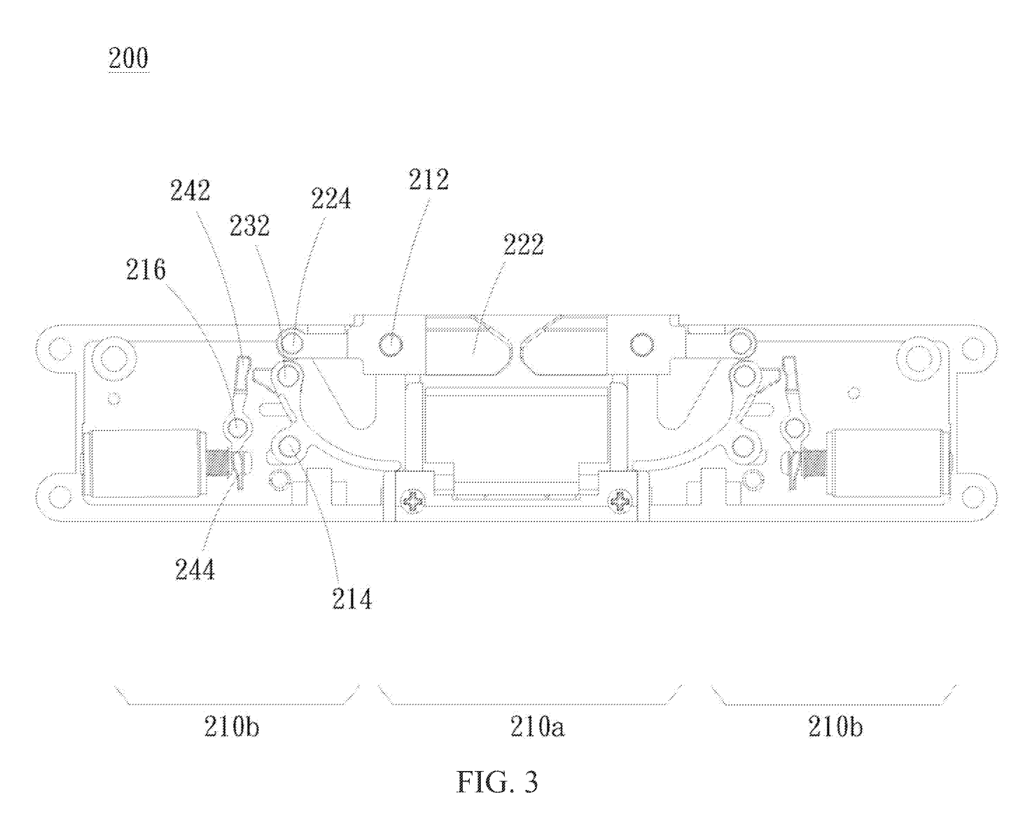

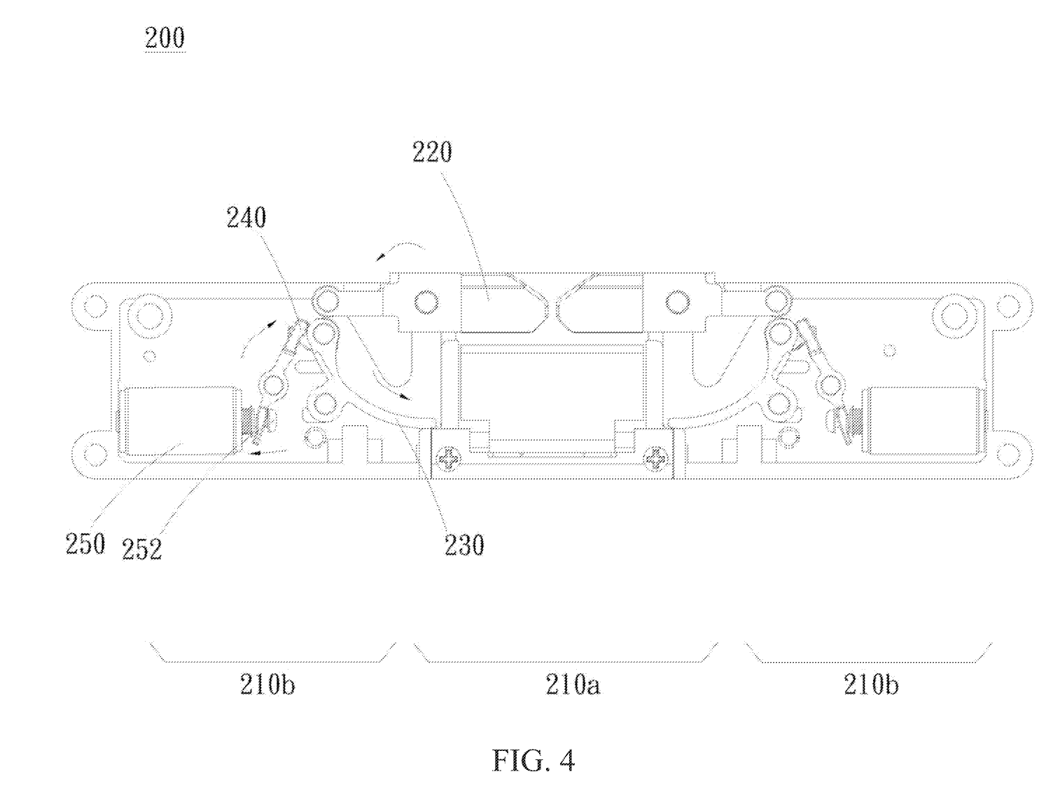

With reference to FIGS. 3 and 4, the base 210 has a central area 210a and two side areas 210b disposed at two sides of the central area 210a. The central area 210a has two first axes 212 and two second axes 214 opposite to each other, and the side area 210b has two third axes 216.

The two doorstops 220 are disposed at the two first axes 212 of the central area 210a, and have a first end 222 and a second end 224 respectively. The two first links 230 are disposed at the two second axes 214 of the central area 210a, and have a third end 232 for holding the two second ends 224 of the two doorstops 220 respectively.

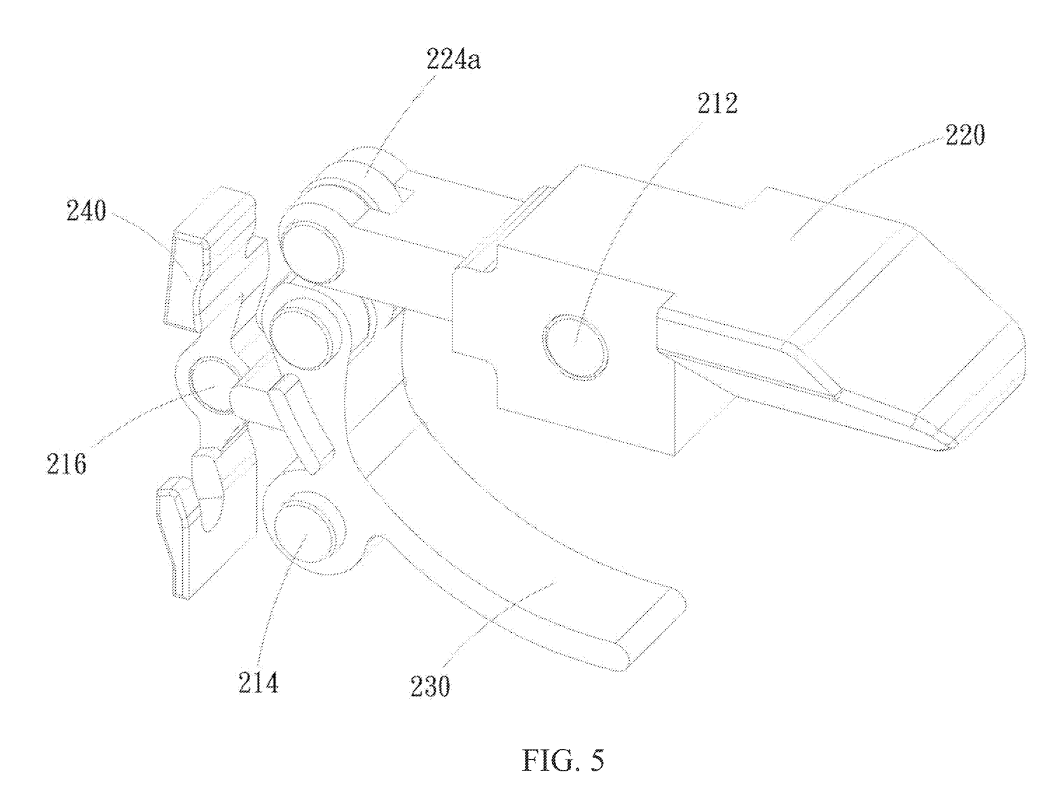

Further, with reference to FIG. 5, the two second links 240 are disposed at the two third axes 216 of the side areas 210b. The two second links 240 have a fourth end 242 and a fifth end 244 respectively, and the fourth end 242 is adapted to hold the third end 232 of the first link 230 in a holding status.

The two solenoid valves 250 are disposed at an outer edge of the two side areas 210b, each the two solenoid valves 250 has a plug 252 respectively, and the plug 252 is adapted to join the fifth end 244 of the second link 240.

Therefore, the cover 260 is adapted to combine with the base 210 to form a receiving space for receiving the two doorstops 220, the two first links 230, the two second links 240 and the two solenoid valves 250.

As a result, when the solenoid valves 250 are not energized, via the specific arrangement of the doorstops 220, the first links 230, the second links 240 and the solenoid valves 250, the fourth end 242 is adapted to hold the third end 232 of the first link 230 to form a holding status so as the doorstops 220 are in a close status.

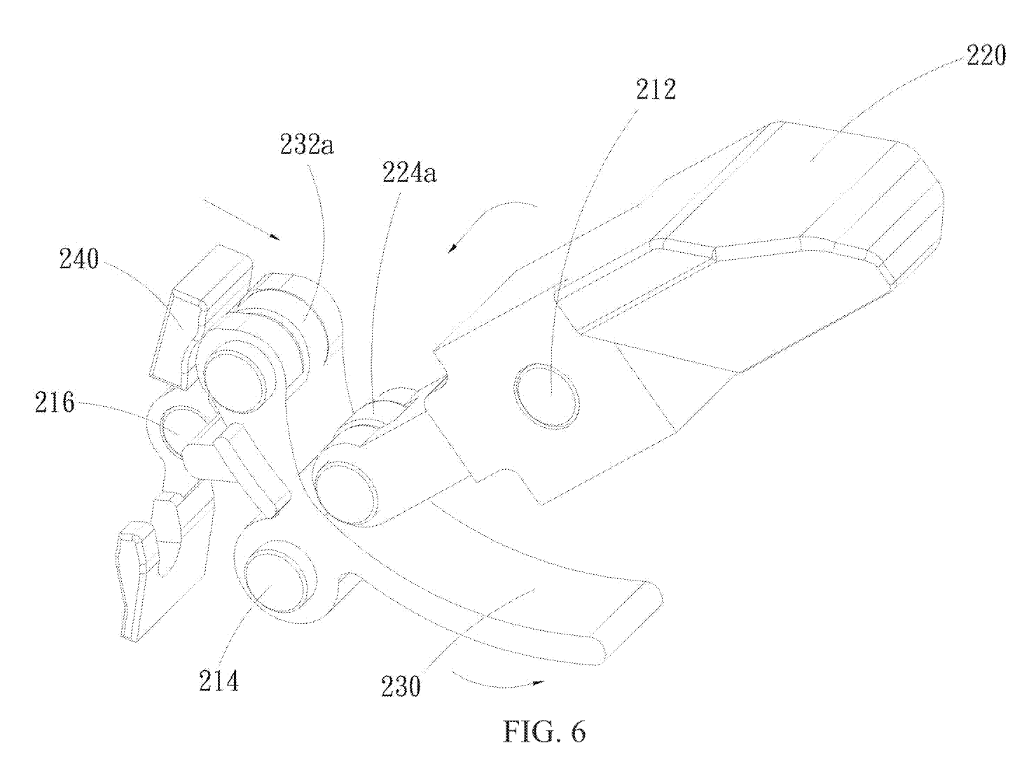

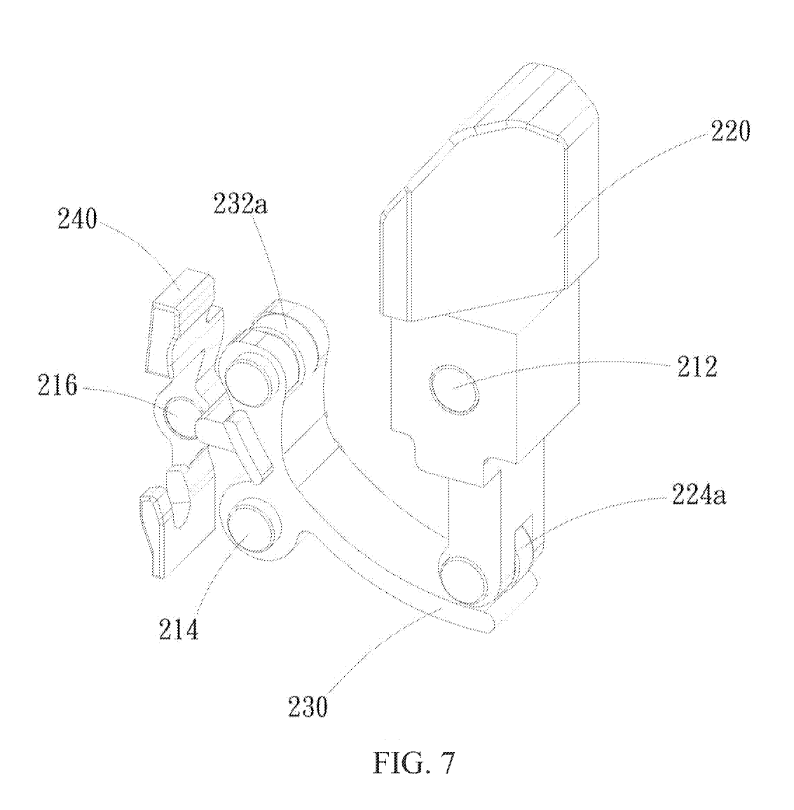

With reference to FIGS. 6 and 7, when the two solenoid valves 250 are energized, the two plugs 252 are adapted to move along the direction opposite the central area 210a and drive the two fifth ends 244 of the two second links 240, the two fourth ends 242 of the two second links 240 thus separate from the third ends 232 of the first links 230. Thus, the third end 232 of the first link 230 rotates along the second axis 214 to produce a displacement, and makes the second end 224 of the doorstop 220 moves down along the first axis 212 (i.e. the first end 222 of the doorstop 220 moves upward along the first axis 212) so as the doorstops 220 are in an open status.

Please refer to FIG. 2 again, the present invention of the exit lock assembly 200 further comprises a first spring 213, a second spring 215 and a third spring 217 disposed on the first axis 212, the second axis 214 and the third axis 216 respectively. When the two solenoid valves 250 are not energized, the doorstops 220, the first links 230 and the second links 240 return to an initial position via the elastic force of the first spring 213, the second spring 215 and the third spring 217, and thus the exit lock assembly 200 goes back to the close status.

As shown in FIG. 2, in the embodiment, the solenoid valve 250 further comprises a fourth spring 254 disposed around the plug 252. Thus, the fourth spring 254 is utilized to return the plug 252 to an initial position when the solenoid valve 250 is not energized.

In addition, a first roller 224a and a second roller 262a are disposed on the second end 222 of the doorstop 220 and the third end 232 of the first link 230 respectively, so as to reduce the friction between the second end 222 of the doorstop 220 and the third end 232 of the first link 230 while moving and effectively prevent the occurrence of stuck situations.

Preferably, as shown in the first embodiment, the first link 230 has an arc-like shape. When the third end 232 of the first link 230 rotates along the second axis 214 to produce a displacement, the second end 224 of the doorstop 220 could rotate along the first axis 212 and move along the arc-like shape while the second end 224 of the doorstop 220 is not in the holding status, and thus the doorstop opened.

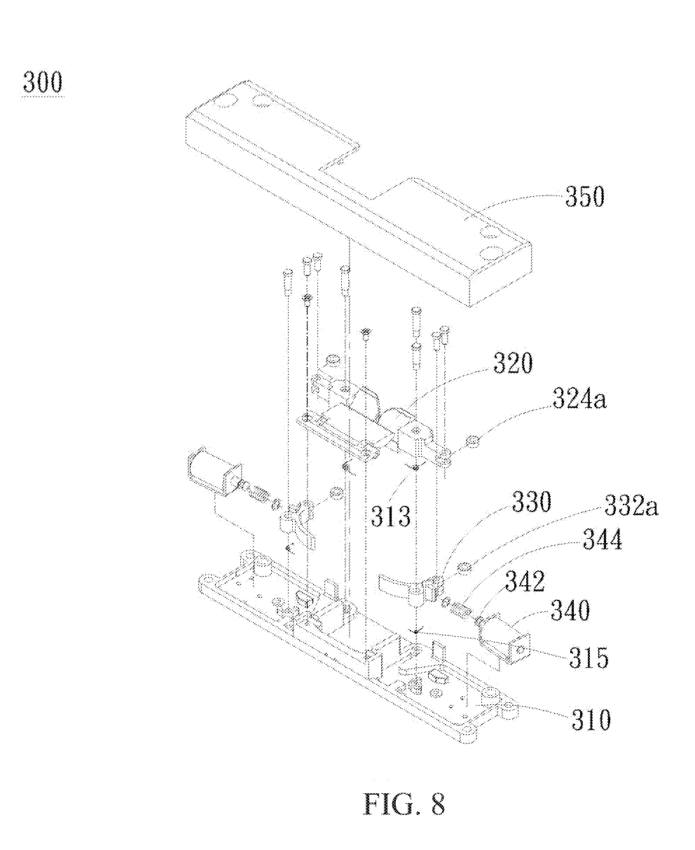

As shown in FIG. 8, a second embodiment of the present invention of an exit lock assembly 300 comprises a base 310, two doorstops 320, two first links 330, two solenoid valves 340 and a cover 350.

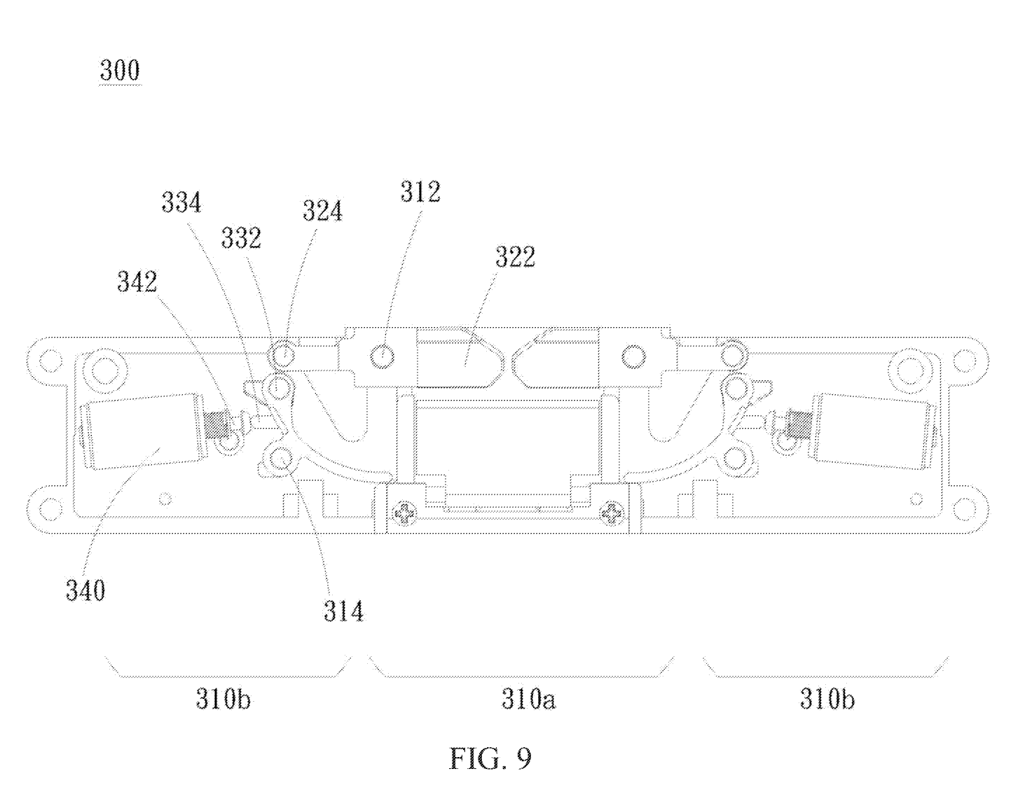

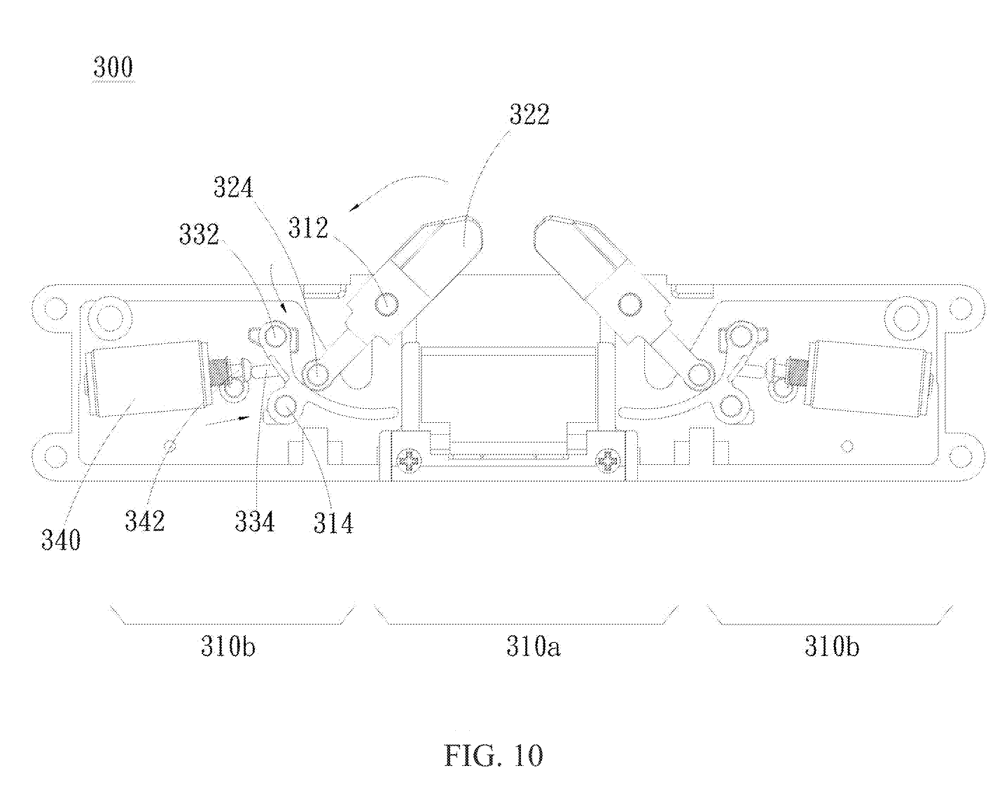

With reference to FIGS. 9 and 10, the base 310 has a central area 310a and two side areas 310b disposed at two sides of the central area 310a, and the central area 310a has two first axes 312 and two second axes 314 opposite to each other.

The two doorstops 320 are disposed at the two first axes 312 of the central area 310a, and have a first end 322 and a second end 324 respectively.

The two first links 330 are disposed at the two second axes 314 of the central area 210a, each the first links 330 has a third end 332 and a projection 334, and the third end 332 is adapted to hold the second end 324 of the doorstop 320 respectively. The two solenoid valves 340 are disposed at the two side areas 310b, each the two solenoid valves 340 has a plug 342 respectively, and the plug 342 hold the projection 334 of the first link 330 in a holding status.

Therefore, the cover 350 is adapted to combine with the base 310 to form a receiving space for receiving the two doorstops 320, the two first links 330 and the two solenoid valves 340.

As a result, when the solenoid valves 340 are not energized, via the specific arrangement of the doorstops 320, the first links 330 and the solenoid valves 340, the plug 342 is adapted to hold projection 334 of the first link 330 to form a holding status so as the doorstops 320 are in a close status.

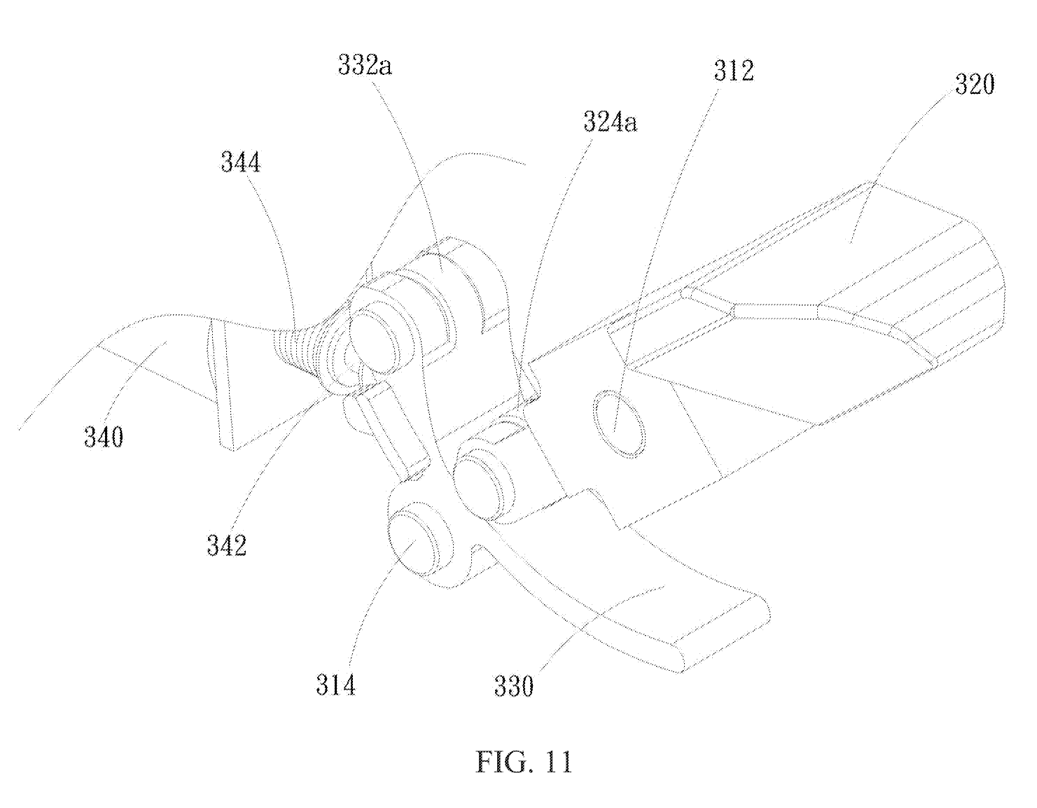

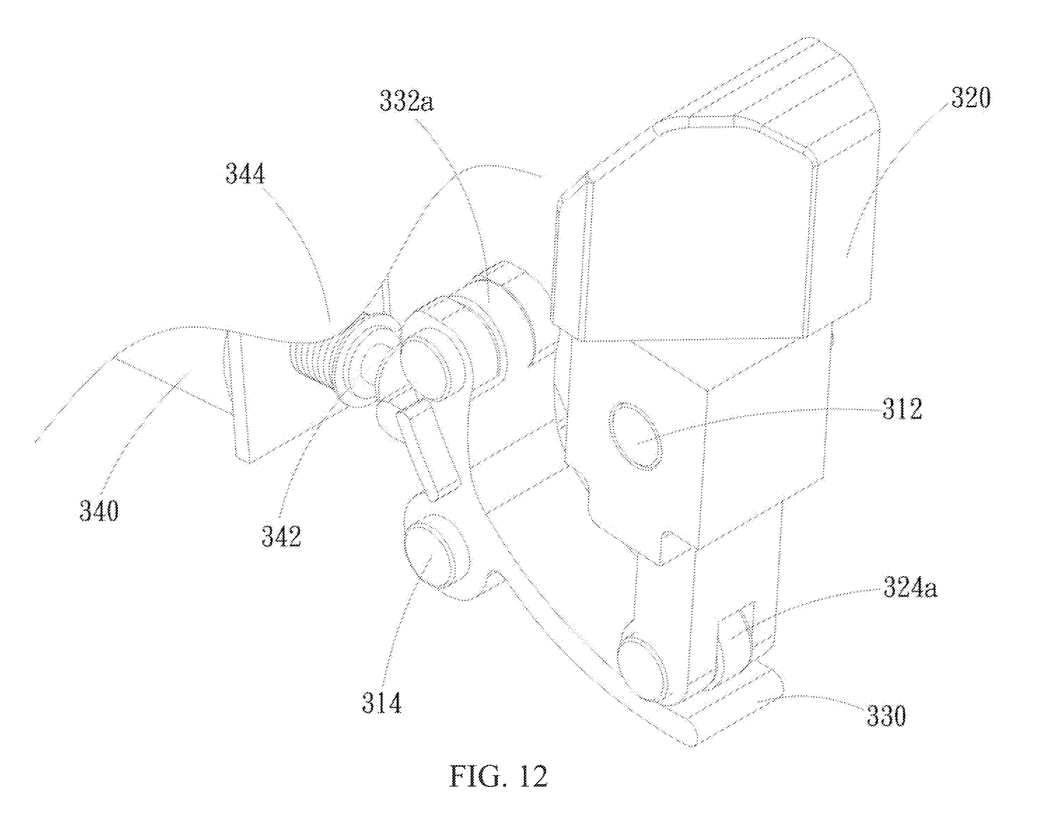

With reference to FIGS. 11 and 12, when the solenoid valves 340 are energized, the two plugs 342 of the two solenoid valves 340 are adapted to move along the direction opposite the central area 310a so as the projection 334 of the two first links 330 break away from the holding status. Thus, the third end 332 of the first link 330 rotates along the second axis 314 to produce a displacement, and makes the second end 324 of the doorstop 320 moves down along the first axis 312 (i.e. the first end 322 of the doorstop 320 moves upward along the first axis 312) so as the doorstops 320 are in an open status.

Please refer to FIG. 8 again, the present invention of the exit lock assembly 300 further comprises a first spring 313 and a second spring 315 disposed on the first axis 312 and the second axis 314 respectively. When the two solenoid valves 340 are not energized, the doorstops 320 and the first links 330 return to an initial position via the elastic force of the first spring 213 and the second spring 215, and thus the exit lock assembly 300 goes back to the close status.

As shown in FIG. 8, in the embodiment, the solenoid valve 340 further comprises a fourth spring 344 disposed around the plug 342. Thus, the fourth spring 344 is utilized to return the plug 342 to an initial position when the solenoid valve 340 is not energized.

In addition, a first roller 324a and a second roller 332a are disposed on the second end 322 of the doorstop 320 and the third end 332 of the first link 330 respectively, so as to reduce the friction between the second end 322 of the doorstop 320 and the third end 332 of the first link 330 while moving and effectively prevent the occurrence of stuck situations.

Preferably, as shown in the second embodiment, the first link 330 has an arc-like shape. The second end 324 of the doorstop 320 could rotate along the first axis 312 and move along the arc-like shape while the second end 324 of the doorstop 320 is not in the holding status, and thus the doorstop opened.

The above disclosure is related to the detailed technical contents and inventive features thereof. People skilled in this field may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. An exit lock assembly, comprising:
a base having a central area and two side areas disposed at two sides of the central area, the central area having two first axes and two second axes opposite to each other, and the side area having two third axes;
two doorstops disposed at the two first axes of the central area, and having a first end and a second end respectively;
two first links disposed at the two second axes of the central area, and having a third end for holding the second end of the doorstop respectively;
two second links disposed at the two third axes of the side areas, and having a fourth end and a fifth end respectively, the fourth end is adapted to hold the third end of the first links in a holding status;
two solenoid valves disposed at an outer edge of the two side areas, the two solenoid valves having a plug respectively, and the plug is adapted to join the fifth end of the second link; and
a cover adapted to combine with the base to form a receiving space for receiving the two doorstops, the two first links, the two second links and the two solenoid valves;
wherein when the solenoid valves are energized, the two plugs of the two solenoid valves move along the direction opposite the central area and drive the two fifth ends of the two second links, the two fourth ends of the two second links thus separate from the third ends of the first links, and the second end of the doorstop moves down.

2. The exit lock assembly as claimed in claim 1, wherein the doorstop, the first link and the second link return to an initial position via a first spring, a second spring and a third spring.

3. The exit lock assembly as claimed in claim 2, wherein the first spring, the second spring and the third spring are disposed on the first axis, the second axis and the third axis respectively.

4. The exit lock assembly as claimed in claim 3, wherein the solenoid valve further comprises a fourth spring disposed on the plug, and the fourth spring is utilized to return the plug to an initial position when the solenoid valve are not energized.

5. The exit lock assembly as claimed in claim 4, wherein a first roller and a second roller are disposed on the second end of the doorstop and the third end of the first link respectively.

6. The exit lock assembly as claimed in claim 1, wherein the first link has an arc-like shape.

7. An exit lock assembly, comprising:
a base having a central area and two side areas disposed at two sides of the central area, the central area having two first axes and two second axes opposite to each other, and the side area having two third axes;
two doorstops disposed at the two first axes of the central area, and having a first end and a second end respectively;
two first links disposed at the two second axes of the central area, each the first links having a third end and a projection, and the third end is adapted to hold the second end of the doorstop respectively;
two solenoid valves disposed at the two side areas, each the two solenoid valves having a plug respectively, and the plug hold the projection of the first link in a holding status; and
a cover adapted to combine with the base to form a receiving space for receiving the two doorstops, the two first links and the two solenoid valves;
wherein when the solenoid valves are energized, the two plugs of the two solenoid valves move along the direction opposite the central area so as the projection of the two first links break away from the holding status, and the second end of the doorstop moves down.

8. The exit lock assembly as claimed in claim 7, wherein the doorstop and the first link return to an initial position via a first spring and a second spring.

9. The exit lock assembly as claimed in claim 8, wherein the first spring and the second spring are disposed on the first axis and the second axis respectively.

10. The exit lock assembly as claimed in claim 9, wherein the solenoid valve further comprises a fourth spring disposed on the plug, and the fourth spring is utilized to return the plug to an initial position when the solenoid valve are not energized.

11. The exit lock assembly as claimed in claim 10, wherein a first roller and a second roller are disposed on the second end of the doorstop and the third end of the first link respectively.

12. The exit lock assembly as claimed in claim 7, wherein the first link has an arc-like shape.
